(19) United States
(12) Patent Application Publication
(10) Pub. No.: US 2026/0352295 A1
(43) Pub. Date: Nov. 5, 2026

(54) SELF-SUPERVISED AI FOR RECONSTRUCTING GENERALIZED CSI FEEDBACK IN CELLULAR NETWORKS

(71) Applicant: Samsung Electronics Co., Ltd., Suwon-si (KR)

(72) Inventors: William Xia, Ozone Park, NY (US); Xiaochuan Ma, Hillsborough, NJ (US); Yan Xin, Princeton, NJ (US); Jianzhong Zhang, Dallas, TX (US)

(21) Appl. No.: 19/641,276

(22) Filed: Apr. 7, 2026

Related U.S. Application Data
(60) Provisional application No. 63/795,186, filed on Apr. 25, 2025.

(51) Int. Cl. H04B 7/06

(52) U.S. Cl. CPC H04B 7/0626; H04B 7/0639

(57) ABSTRACT

Methods and apparatuses for a self-supervised AI for reconstructing generalized CSI feedback in a wireless communication system. The method of a BS comprises: recovering at least one RB-level precoder based on at least one low-resolution RB-level precoder for obtaining a precoder gain; configuring, based on the at least one RB-level precoder, an up-sampling operation for CSI to train a self-supervised learning model without information including at least one of UL CSI or a reference signal; reconstructing, based on a physics-based loss function, the CSI using the self-supervised learning model for DL CSI; and transmitting, to a UE, signals including information associated with the reconstructed CSI.

### CROSS-REFERENCE TO RELATED APPLICATIONS AND CLAIM OF PRIORITY

The present application claims priority to U.S. Provisional Patent Application No. 63/795,186, filed on Apr. 25, 2025. The contents of the above-identified patent documents are incorporated herein by reference.

### TECHNICAL FIELD

The present disclosure relates generally to wireless communication systems and, more specifically, the present disclosure relates to a self-supervised artificial intelligence (AI) for reconstructing generalized channel state information (CSI) feedback in a wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a self-supervised AI for reconstructing generalized CSI feedback in a wireless communication system.

In one embodiment, a base station (BS) in a wireless communication system is provided. The BS comprises a processor configured to recover at least one resource block (RB)-level precoder based on at least one low-resolution RB-level precoder for obtaining a precoder gain, configure, based on the at least one RB-level precoder, an up-sampling operation for channel state information (CSI) to train a self-supervised learning model without information including at least one of uplink (UL) CSI or a reference signal, reconstruct, based on a physics-based loss function, the CSI using the self-supervised learning model for downlink (DL) CSI. The BS further comprises a transceiver operably coupled to the processor, the transceiver configured to transmit, to a user equipment (UE), signals including information associated with the reconstructed CSI.

In another embodiment, a method of the BS in a wireless communication system is provided. The method comprises recovering at least one RB-level precoder based on at least one low-resolution RB-level precoder for obtaining a precoder gain; configuring, based on the at least one RB-level precoder, an up-sampling operation for CSI to train a self-supervised learning model without information including at least one of UL CSI or a reference signal; reconstructing, based on a physics-based loss function, the CSI using the self-supervised learning model for DL CSI; and transmitting, to a UE, signals including information associated with the reconstructed CSI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of cellular network operates precoder feedback process according to various embodiments of the present disclosure;

FIG. 8 illustrates an example of precoder reconstruction according to various embodiments of the present disclosure;

FIG. 9 illustrates an example of ViT block comprising layer norms, multi-headed attention, a multi-layer perceptron, and skip connections according to various embodiments of the present disclosure;

FIG. 10 illustrates an example of down-sampled wireless channel, assuming the first RB of each subband is used, according to various embodiments of the present disclosure;

FIG. 11 illustrates an example of random and structured masks using sample of N_RBpSB=4 or equivalently a masking ratio of 0.75 according to various embodiments of the present disclosure;

FIG. 12 illustrates a flowchart of a BS method for training vision learning-based precoder reconstruction according to various embodiments of the present disclosure;

FIG. 13 illustrates a flowchart of a BS method for precoder reconstruction (inference in deployment) using MCANet according to various embodiments of the present disclosure;

FIG. 14 illustrates an example of RB domain and delay domain for a sample wireless channel according to various embodiments of the present disclosure;

FIG. 15 illustrates a flowchart of a BS method using a physics-informed loss function of self-supervised model training according to various embodiments of the present disclosure;

FIG. 16 illustrates an example of side effect of partial spectrum usage in a sensor network according to various embodiments of the present disclosure;

FIG. 17 illustrates an example of sensor network when partial spectrum is used according to various embodiments of the present disclosure; and

FIG. 18 illustrates a flowchart of a BS method for a self-supervised AI for reconstructing generalized CSI feedback according to various embodiments of the present disclosure.

### DETAILED DESCRIPTION

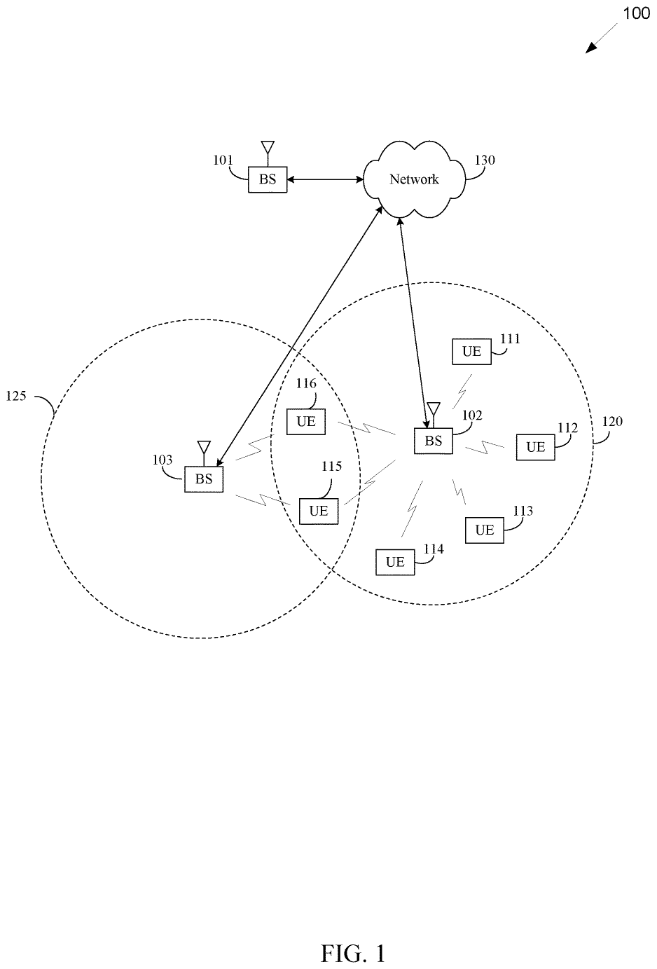

FIG. 1 through FIG. 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate any signals and/or information supporting a self-supervised AI for reconstructing generalized CSI feedback in a wireless communication system, at a gNB 101-103, in a wireless communication system. In certain embodiments, and one or more of the gNBs 101-103 includes circuitry, programing, or a combination thereof, to support a self-supervised AI for reconstructing generalized CSI feedback in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

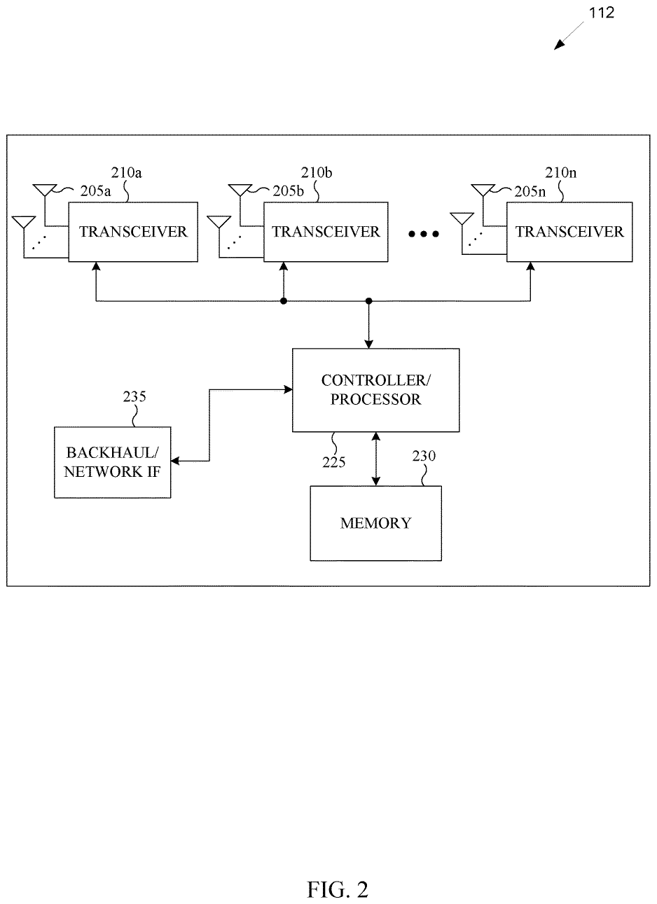

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support any operation of a self-supervised AI for reconstructing generalized CSI feedback in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

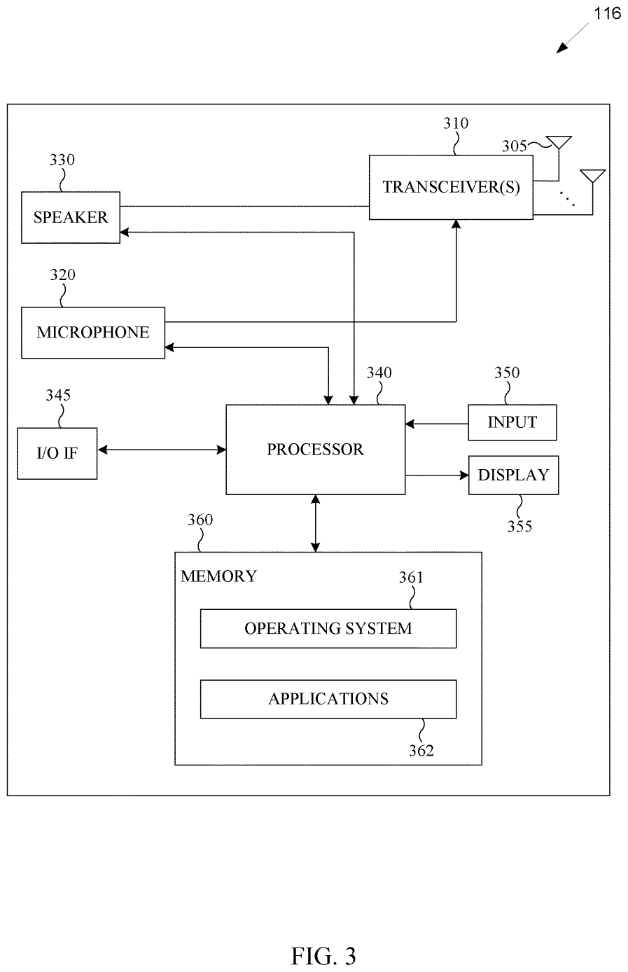

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate any signals and/or information for supporting an operation of a self-supervised AI for reconstructing generalized CSI feedback in a wireless communication system, at the gNB 101-103, in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

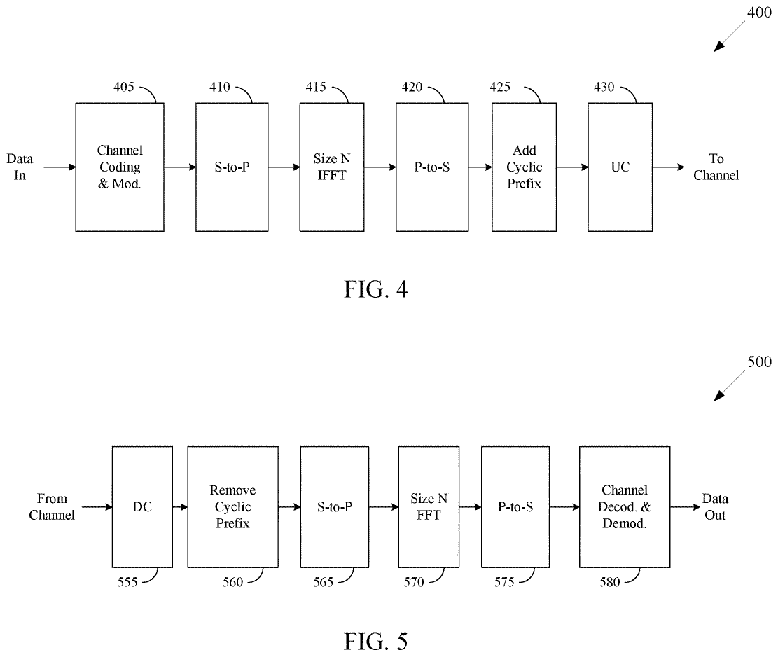

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

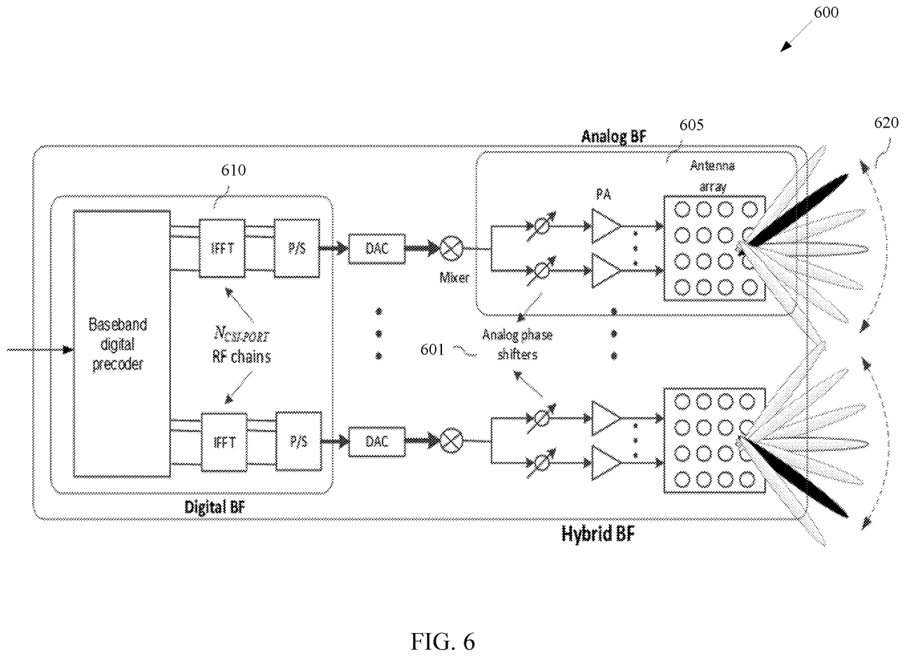

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (~10 dB additional loss at 100 m distance), larger number of and sharper analog beams (hence larger number of radiators in the array) may compensate for the additional path loss.

In order to maximize downlink (DL) channel gain in modern MIMO systems, obtaining accurate CSI is critical. Unlike in time-division duplexing (TDD) systems, frequency-division duplexing (FDD) systems do not enjoy the benefits of full channel reciprocity between uplink (UL) and DL CSIs, and relies on either implicit or explicit DL CSI feedback from users. As communication systems march towards higher and higher carrier frequencies in the regime of massive MIMO technologies, the desired higher energy and spectrum efficiency as well as throughput potential are plagued by the significant increase in feedback overhead due to larger antenna arrays and increased number of users. To reduce the feedback overhead, 5G cellular networks have user equipment that sends implicit CSI feedback per subband (SB) instead of per RB to reduce the feedback overhead. However, precoder gain and subsequently DL throughput performance can suffer severely under channels with frequency selective fading. Some learning-based CSI feedback mechanisms can achieve feedback efficiency that outperform standardized approaches such NR type I and type II and other compressive-sensing-based solutions. The present disclosure aims to leverage powerful vision techniques to learn inherent channel characteristics, thus enabling accurate reconstruction of generalized DL CSI.

The term “base station” or “BS” can refer to any component (or collection of components) configured to provide wireless access to a network. This encompasses a wide variety of items such as a transmit point (TP), transmit-receive point (TRP), an enhanced base station (eNodeB or eNB or gNB), a macrocell, a femtocell, a WiFi access point (AP), a distributed unit (DU), a radio unit (RU), etc. Generally speaking, these devices and their operation are governed by standard wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Some embodiments of the present disclosure are described assuming the CSI reconstruction task in FDD cellular system. However, the same/similar principles and related signaling methods and configurations can also be used for any other signal recovery/reconstruction problem.

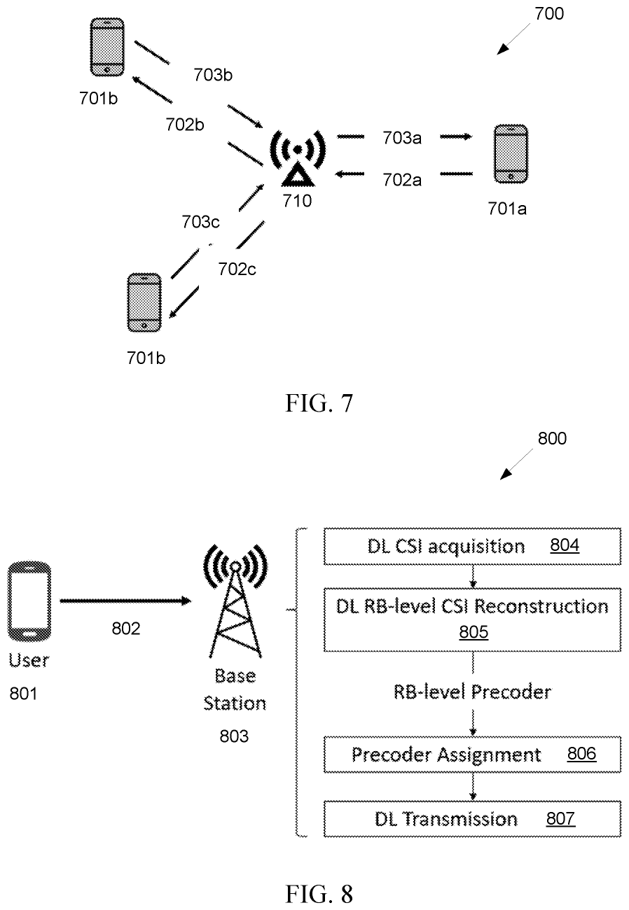

FIG. 7 illustrates an example of cellular network operates precoder feedback process 700 according to various embodiments of the present disclosure. An embodiment of the cellular network operates precoder feedback process 700 shown in FIG. 7 is for illustration only.

An example of a wireless network is shown in FIG. 7. A BS 710 sends an RB-level reference signal via the interface 702a, 702b, and 702c to user terminals 701a, 701b, and 701c. Subsequently, the user terminals calculate the optimal RB-level precoder by using the estimated channels obtained from the reference signals and feed back to BS via the interface 703a, 703b, and 703c.

FIG. 8 illustrates an example of precoder reconstruction 800 according to various embodiments of the present disclosure. An embodiment of the precoder reconstruction 800 shown in FIG. 8 is for illustration only.

FIG. 8 illustrates the precoder reconstruction problem in a cellular network at the BS. As illustrated by FIG. 8, in order to reduce uplink feedback overhead, a user terminal (801) can either down-sample the RB-level precoder or calculate SB-level precoder and send it back to BS (803) through interface 802. The BS receives this feedback at a lower resolution and may perform a precoder reconstruction (805) operation to recover the RB-level precoder which is used for DL transmission (807). However, since DL CSI acquisition (804) is obtained potentially at the SB-level or even non-uniformly at the RB-level, this can lead to degradation of performance in terms of channel gain and throughput under channels with large delay spread (i.e., high frequency selectivity). This is due to the fundamentally irrecoverable loss of channel information from the down-sampling operation at the RB-level CSI. Thus, it is imperative to provide a solution capable of recovering RB-level precoders from low resolution CSI with as high accuracy as possible so that it cannot only reduce the uplink feedback overhead, but also maintain the channel gain from RB-level precoders. Concretely, operation 805 is the focus of the present disclosure.

In one embodiment, components of the vision transformer (ViT) architecture are utilized as a backbone and will provide further detail for the understanding of the provided method to follow.

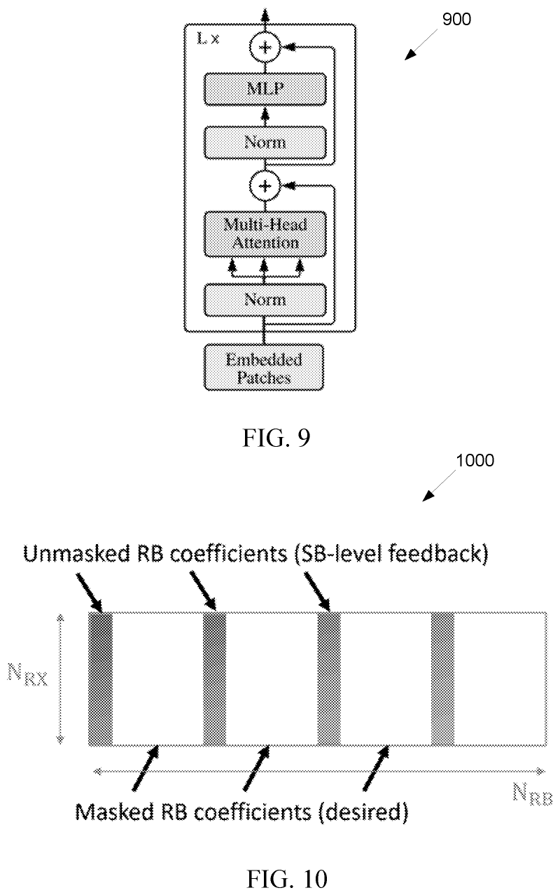

The ViT architecture takes an image which has been divided into patches, computes patch and positional embeddings, then performs a linear projection of these patches. These embedded patches are then passed through an attention-based mechanism which refers to simply as a ViT block as shown in FIG. 9.

FIG. 9 illustrates an example of ViT block 900 comprising layer norms, multi-headed attention, a multi-layer perceptron, and skip connections according to various embodiments of the present disclosure. An embodiment of the ViT block 900 shown in FIG. 9 is for illustration only.

As illustrated in FIG. 9, this ViT block passes the embedded patches through a variety of layers including normalization, multi-head attention, and a multi-layer perceptron (MLP). Residual connections are also used at select points within the block.

In FDD cellular networks, user terminals estimate DL CSI using reference signals, calculate the channel precoder and feeds it back to the BS to be used for DL beamforming and transmission to enhance DL throughput. Due to limited air resources and increased overhead of CSI feedback owing to larger antenna arrays, more users, etc., user terminals are not allowed to feedback full resolution precoders to a BS. Instead, they generally feedback precoders in a subband-level instead of RB-level resolution. This leads to severe degradation of DL channel gain when these lower resolution precoders are processed and used for precoding, particularly in channels with large delay spread. Thus, operators aim to design a non-linear mapping function at the BS from low resolution precoders to RB-level (high resolution) ones. However, the down-sampling from an RB-level to an SB-level precoder can cause an aliasing phenomenon which is theoretically irreversible. It is impossible to find an ideal mapping from an SB-level to the true RB-level precoder.

The present disclosure provides methods to find a mapping function at the BS from low-resolution (i.e., SB-level) precoders to their RB-level precoder counterparts by introducing a data-driven deep learning approach that is capable of recovering the high-resolution channel information even subject to the most extreme consequence of down-sampling: severe aliasing.

While side information such as UL CSI may be used to address these cases, this information can be unreliable due to the partial reciprocity of the FDD channel, and intermittent availability of such side information. The present disclosure can enable the BS to recover the high-quality RB-level precoder based on the provided framework even in the presence of aliasing effects.

In one embodiment, a recovering operation is provided, via a BS based on AI, for one or more RB-level precoders from one or more generalized low resolution RB-level precoders to enhance precoder gain, wherein the one or more generalized low resolution RB-level precoders are associated with uniform information loss or non-uniform information loss via a channel image masking design.

In one embodiment, a configuring operation of a framework for CSI up-sampling to train and deploy a deep learning model is provided while avoiding use of side information that includes at least one of UL CSI or a reference signal.

In one embodiment, a self-supervised approach with a physics-based loss function to enhance DL CSI is provided.

In one embodiment, the processing method which then enables a vision learner to perform the desired CSI reconstruction task is provided. This section describes the core of the first embodiment.

In one embodiment, the direct parallel between images with missing patches and down-sampled DL CSI information is provided, and a training methodology specific for the CSI recovery/up-sampling problem is provided. As illustrated in FIG. 10, it demonstrates a toy example of a wireless channel in a frequency or an RB domain, which can be represented for our purposes as an N_{RX}×N_{RB} dimensional image.

FIG. 10 illustrates an example of down-sampled wireless channel 1000, assuming the first RB of each subband is used, according to various embodiments of the present disclosure. An embodiment of the down-sampled wireless channel 1000 shown in FIG. 10 is for illustration only.

The unmasked RBs comprise the SB-level feedback received at the BS, and the reconstruction of the rest of the masked coefficients is the desired mapping. This problem is directly parallel to a masked image reconstruction problem and can be solved as such. Several approaches to standard image reconstruction use random masking, which tends to give the best performance in terms of reconstructed image fidelity.

In one embodiment, both random masking and the structured masking are combined together. Structured masking is used to directly imitate the RB-domain down-sampling into the SB-level precoder, while random masking is used to assist the vision network to learn the underlying distribution of the channel image. While standard masking approaches use square patches for images, the use of antenna-dimensioned strips (i.e., 1×N_{RX} sized patches) is provided.

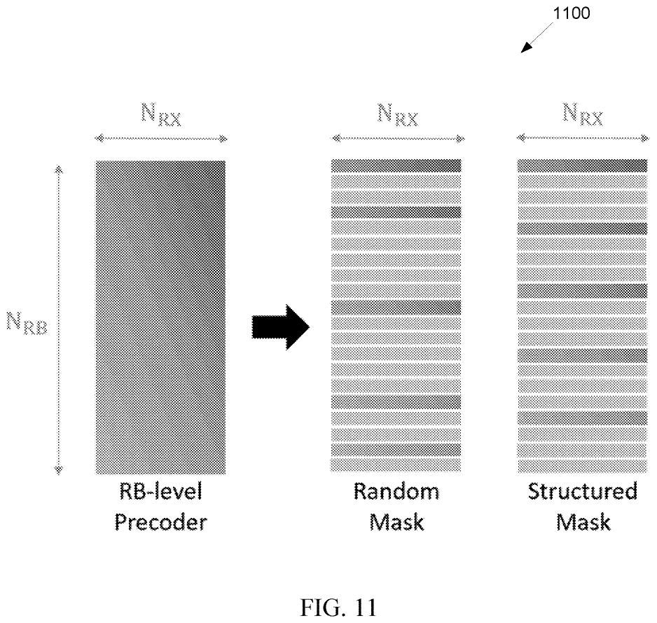

Here N_{RX} denotes a number of antenna ports at the BS. This design directly allows the structured masking to reflect the relation between RB and SB-level precoders. For training the model detailed in the following section, it may take a training batch and apply random masking to half of the samples, and structured masking to the other half as shown in FIG. 11.

FIG. 11 illustrates an example of random and structured masks 1100 using sample of N_RBpSB=4 or equivalently a masking ratio of 0.75 according to various embodiments of the present disclosure. An embodiment of the random and structured masks 1100 shown in FIG. 11 is for illustration only.

Thus, in total with [Nₛₐₘₚ, 2, N_{RX}, N_{RB}] dimensional input (with 2 being for the real and imaginary components of the channel), it masks Nₛₐₘₚ/2 samples randomly, and mask Nₛₐₘₚ/2 with structured masking for any factor of N_{RBpSB} chosen.

The vision-based deep learning model, called masked channel autoencoder network (MCANet) is provided as a solution to the DL low resolution (SB-level) precoder up-sampling problem. The model used in this embodiment does not restrict to a specific type of model and can be constructed with other layers or network architectures.

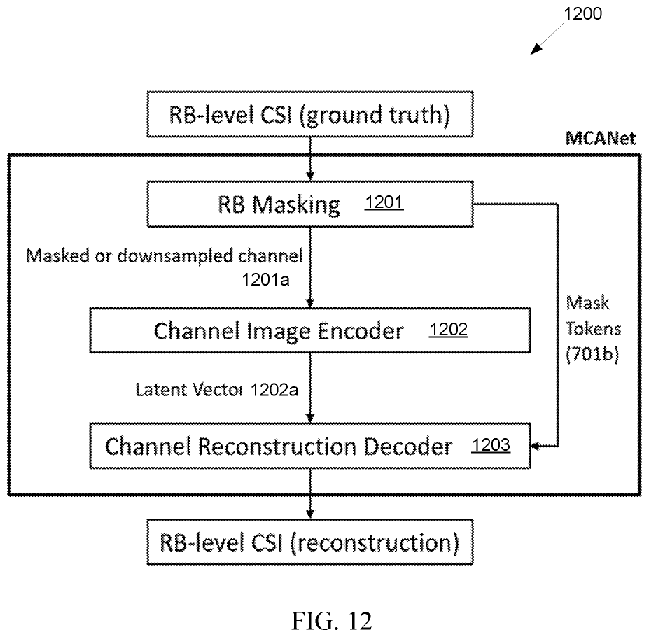

FIG. 12 illustrates a flowchart of a BS method 1200 for training vision learning-based precoder reconstruction according to various embodiments of the present disclosure. The method 1200 may be performed by a BS (e.g., 101-103 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As shown in FIG. 12, this model is a self-supervised learning approach and comprises three key modules as shown below.

In one example, a self-supervised learning approach comprises an RB masking (1201). This part takes the ground truth DL precoder, which it denotes H_{RB} and first performs patch and positional embeddings on each patch before transforming it via random and random masking as described in the present disclosure. The output of this module is a mix of SB-level CSI H_{SB} and randomly down-sampled precoder RBs H_{RB,DS} based on the factor N_{RBpSB}. Let the output of this module be the batch of N_{BATCH} training samples denoted as H_{Masked} (1201a). This module also provides the mask tokens t_{Mask} (1201b), which provide positional information of the masked patches to later modules.

In one example, a self-supervised learning approach comprises channel image encoder (1202) is provided. This module is designed to encode the remaining visible patches of the precoder into a lower dimensional latent vector (1202a), and is embodied by several ViT blocks as described in the present disclosure. The encoder has access to the mask tokens corresponding only to the visible patches t_{Mask}[I_{visible}], where I_{visible} denotes the indices of the unmasked RBs. Which is the same information expected to be available when handling SB-level precoders from the system view. The encoder mapping operation is given by

z=EN(H_{Masked}) (1).

In one example, a self-supervised learning approach comprises channel reconstruction decoder (1203). The decoder module is tasked with reconstructing the DL precoder using the latent vector z and mask tokens t_{Mask}. This prediction of the high resolution (RB-level) precoder is denoted Ĥ_{RB}. While having a shallower architecture than the encoder (less blocks/layers), the decoder is similar to embodied ViT blocks. As the decoder may process the embeddings of all patches, this is more lightweight design that is chosen for computational efficiency. The decoder mapping operation is given by

Ĥ_{RB}=DE(z,t_{Mask}) (2)

It immediately follows from the RB Masking 1201 that the present disclosure can be used for CSI reconstruction given both uniform and non-uniform down-sampling of the RB-level precoder. This is critical as this masking enables MCANet to be flexibly applied for both full band and partial band CSI feedback.

In one embodiment, to evaluate the channel gain obtained from precoders, a key performance indicator (KPI) called normalized channel gain (NCG) which is the complex cosine similarity is used between channels h and precoder f as given below:

$$NCG = \frac{\vert {h}^{H} f \vert}{‖ h ‖ ‖ f ‖} . \qquad ( 3 )$$

The nominator |h^{H}f| represents the actual channel gain obtained from the precoder and the denominator aims to normalize the channel and the precoder.

While standard image reconstruction tasks utilize patch or pixel MSE between the ground truth image and reconstructed image for loss calculation during model training, an augmentation of the NGC metric is used, as it gives the similarity between channel directions, and is used as our main KPI. The loss is defined as:

$${ℒ}^{c s s} ( {h}_{i} , {\hat{h}}_{i} ) = {log}_{10} ( 1 / NCG ) = \frac{‖ {h}_{i} ‖ ‖ {\hat{h}}_{i} ‖}{\vert {h}_{i} {\hat{h}}_{i} \vert} . \qquad ( 4 )$$

In equation (4), ĥᵢ is the predicted RB-level precoder from the up-sampling the SB-level DL feedback for RB i. Note that this loss is computed per sample in the batch and per RB.

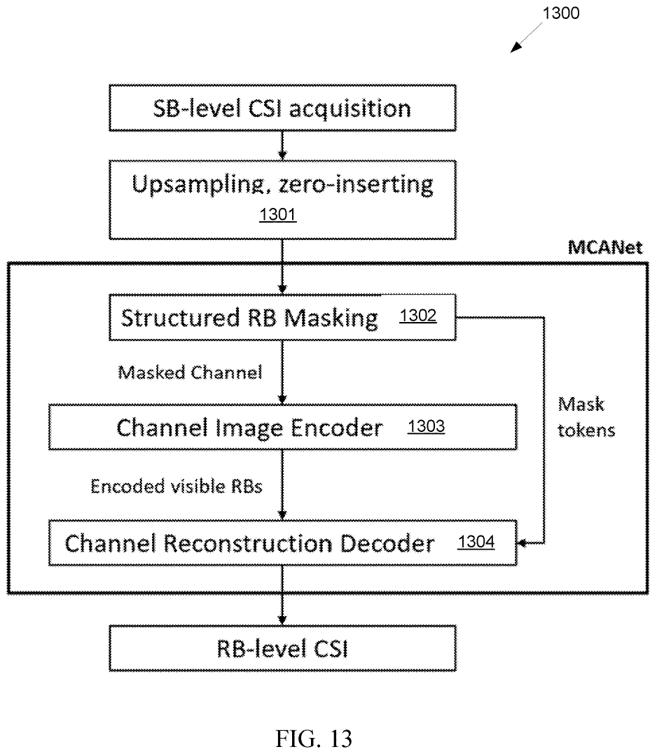

FIG. 13 illustrates a flowchart of a BS method 1300 for precoder reconstruction (inference in deployment) using MCANet according to various embodiments of the present disclosure. The method 1300 may be performed by a BS (e.g., 101-103 as illustrated in FIG. 1). An embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

In FIG. 13, a process of training MCANet is provided. FIG. 13 illustrates the operation of MCANet during inference time and how it may be implemented as a DL CSI up-sampling module. During deployment (inference), the model inputs are low resolution (can be SB-level) precoders H_{SB} (acquired at the BS side), which have been up-sampled via zero-padding. Also, during inference, the RB masking (1302) module uses only structured masking when reconstructing from SB-level precoders to precisely reflect the received down-sampled precoders.

In one embodiment, the zero-inserting (1301) is performed only to match the dimensions of the SB-level precoder to the RB-level precoder, as well as structuring the RBs into expected positions for the RB masking (1302) operation of MCANet and patch/positional embedding steps of the channel image encoder (1303) and channel reconstruction decoder (1304).

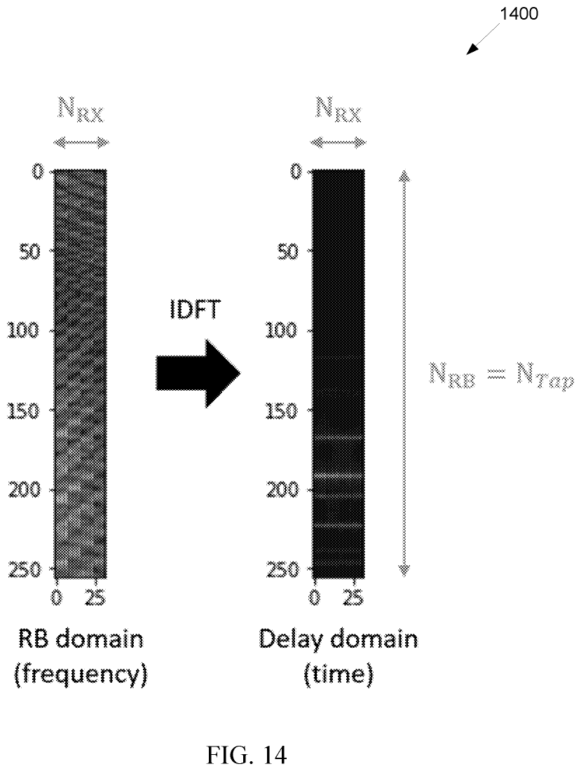

In one embodiment, a physics-informed loss function is provided. While from an imaging perspective, the frequency domain channel image His dense, the image is significantly sparser in the delay domain (power concentrated at a small number of elements relative to size of the image). This can be seen by the RB (frequency) domain channel image compared to the delay tap (time domain) channel image shown in FIG. 14.

FIG. 14 illustrates an example of RB domain and delay domain for a sample wireless channel 1400 according to various embodiments of the present disclosure. An embodiment of the RB domain and delay domain for a sample wireless channel 1400 shown in FIG. 14 is for illustration only.

As illustrated in FIG. 14, it may leverage l₁-based loss or regularizing terms, given as

$${ℒ}_{Total} ( h , \hat{h} ) = \frac{1}{{N}_{RB}} {\sum }_{i} {ℒ}_{i}^{CCS} + \frac{λ}{{N}_{RX}} {\sum }_{n} {ℒ}_{n}^{{ℓ}_{1}} = {log}_{10} \frac{‖ {h}_{i} ‖ ‖ {\hat{h}}_{i} ‖}{\vert {h}_{i}^{H} {\hat{h}}_{i} \vert} + \frac{λ}{{N}_{RX}} {\sum }_{n} {\sum }_{t} \vert {ℱ}^{- 1} {\{ {h}_{n} \}}_{t} \vert {ℱ}^{- 1} {\{ {\hat{h}}_{n} \}}_{t} \vert . \qquad ( 5 )$$

In equation (5), A is the weighting term of the regularizer, and [symbol] {·} denotes the inverse discrete Fourier transform (IDFT) from the RB (frequency) domain to delay tap (time) domain. hᵢ and ĥᵢ denote the ground truth precoders and are 1-D vectors of dimension N_{RX} (there exists N_{RB} total precoders). hₙ and ĥₙ denote the RB domain channels per antenna which are 1-D vectors of dimension N_{RB}. Thus, the first term encourages reconstruction of the precoders, while the l₁ regularizing can aid in learning particularly when severe aliasing is encountered from high delay spread wireless channels.

For an arbitrary signal X∈ [symbol] in frequency domain and its down-sampled signal

$${X}_{D S} = X [ 0 \text{::} D ] ∈ {ℂ}^{\frac{N}{D}} .$$

$$If x [ n ] \neq 0$$

for any n≥N/D, aliasing effect occurs after down-sampling and it cannot be recovered to the original version in general cases. Due to this, peaks in the time domain exist for the masked RB-level precoder (equivalent to zero insertion up-sampling of SB-level precoder) that are absent from the ground truth RB-level precoder. This provided loss can then encourage sparsity in the delay domain to help the network suppress aliased peaks during training.

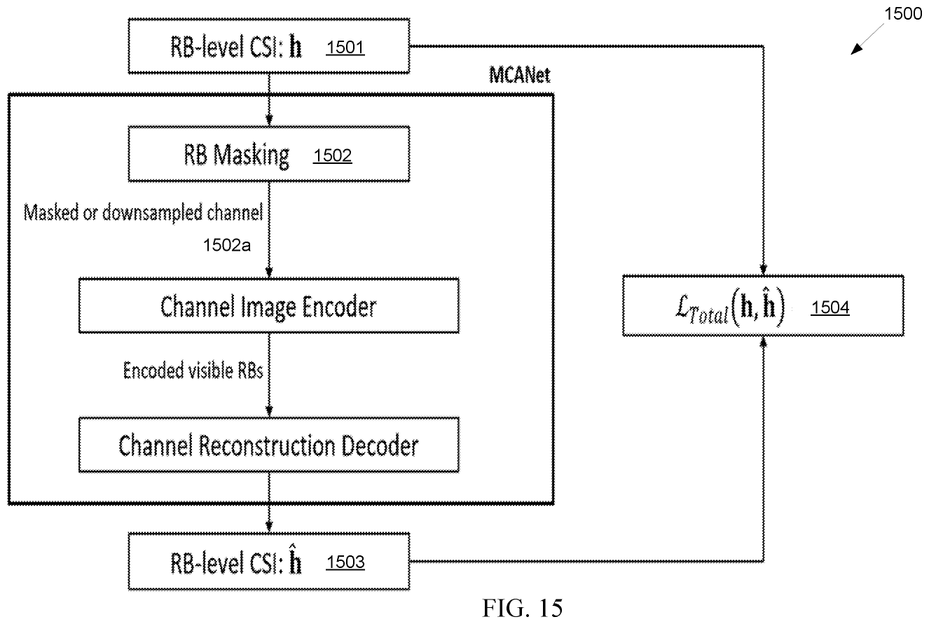

FIG. 15 illustrates a flowchart of a BS method 1500 using a physics-informed loss function of self-supervised model training according to various embodiments of the present disclosure. The method 1500 may be performed by a BS (e.g., 101-103 as illustrated in FIG. 1). An embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

FIG. 15 illustrates the training process of using this physics-informed loss function as an alternative embodiment of training MCANet (first embodiment). The ground truth RB-level CSI (1501) and reconstructed RB-level CSI (1503) are used to compute the loss [symbol] for backpropagation during training of the network. As illustrated in FIG. 15, the physics-informed loss is designed with the knowledge that the down-sampled channel 1502a can exhibit time-domain aliasing and that the ground truth high resolution RB-level CSI may be sparser in such cases and serves as a powerful additional component to the first embodiment of the present disclosure.

To reduce feedback overhead, precoders are transmitted back from UEs to the BS at a lower resolution (e.g., per SB), resulting in performance degradation in terms of channel gain in frequency selective fading channels. The user calculates the optimal precoder for each SB and feedback to BS. In some embodiments, autoencoder structure applies to compress and recovers the DL CSI by exploiting both the delay and beam sparsity, but provided that these learned encoders and decoders may be deployed at the UE and BS, respectively.

In one embodiment, side information such as UL CSI is utilized to design filters to handle the aliasing problem of down-sampling high delay spread channels. However, this assumes the availability of UL CSI and dependence on the partial reciprocity of the FDD channel.

In one embodiment, learning-based approach applies to reduce the number of precoder feedback overhead per SB by leveraging the channel sparsity in beam domain. The performance improvement is limited since it does not exploit the delay sparsity.

In one embodiment, new use-cases for next generation cellular networks are provided by providing more efficient DL CSI feedback for high DS spread scenarios or high-frequency band communications with limited feedback resources.

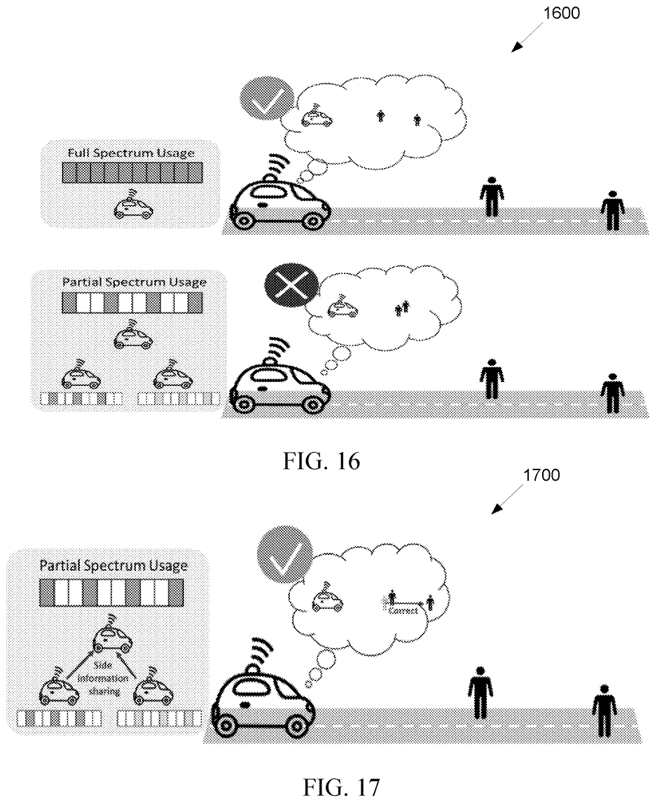

In one embodiment, the co-existence of sensors in a large sensor network is provided. For example, for future next generation self-driving systems, the mmWave radars mount on vehicles in urban area may crash due to the mutual interference: (i) to avoid sensor network crashing, coordinated sensor network may evenly assign partial spectrum for each vehicle, leading to lower detectable distance. For objects with distance larger than the detectable distance, the so-called aliasing effect may occur and mistake far objects as near objects as shown in FIG. 16; and (ii) by exchanging or receiving side information and applying the disclosed approach, the vehicle can successfully correct the wrong estimate.

FIG. 16 illustrates an example of side effect of partial spectrum usage 1600 in a sensor network according to various embodiments of the present disclosure. An embodiment of the side effect of partial spectrum usage 1600 shown in FIG. 16 is for illustration only.

FIG. 17 illustrates an example of sensor network 1700 when partial spectrum is used according to various embodiments of the present disclosure. An embodiment of the sensor network 1700 shown in FIG. 17 is for illustration only.

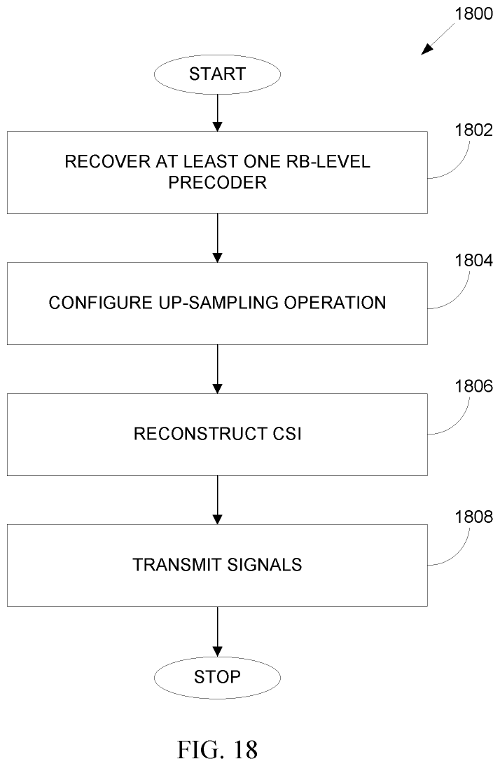

FIG. 18 illustrates a flowchart of a BS method 1800 for a self-supervised AI for reconstructing generalized CSI feedback according to various embodiments of the present disclosure. The method 1800 may be performed by a BS (e.g., 101-103 as illustrated in FIG. 1). An embodiment of the method 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

As illustrated in FIG. 18, a method 1800 of a BS begins at step 1802. In step 1802, the BS recovers at least one RB-level precoder based on at least one low-resolution RB-level precoder for obtaining a precoder gain.

Subsequently, in step 1804, the BS configures, based on the at least one RB-level precoder, an up-sampling operation for CSI to train a self-supervised learning model without information including at least one of UL CSI or a reference signal.

Next, in step 1806, the BS reconstructs, based on a physics-based loss function, the CSI using the self-supervised learning model for DL CSI.

Finally, the BS in step 1808, the BS transmits, to a UE, signals including information associated with the reconstructed CSI.

In step 1802, the at least one low-resolution RB-level precoder is identified, based on a channel image masking operation, with a uniform or non-uniform information loss for a down-sampling operation.

In one embodiment, the BS reconstructs the RB-level precoder using a random masking operation and a structured masking operation for reconstructing the CSI.

In some embodiments, the structured masking operation is identified to directly imitate an RB-domain down-sampling to at least one SB-level precoder, antenna-dimensioned strips associated with patches for images being used for the structured masking operation to identify a relationship between the at least one RB-level precoder and the at least one SB-level precoder; and the random masking operation is identified to assist a vision network for a distribution of a channel image.

In one embodiment, the BS performs an RB masking operation using a ground truth DL precoder to perform, based on a random masking operation or a uniform masking operation, a positional embedding operation on each patch before transforming the patch and generates, based on the RB masking operation, mask tokens including positional information of the patch that is masked by the random masking operation or the uniform masking operation.

In some embodiments, the self-supervised learning model includes the RB masking operation, a channel image encoding operation, and a channel reconstruction decoding operation for obtaining an RB-level CSI prediction based on RB-level CSI.

In one embodiment, the BS performs, based on a channel image encoder, the channel image encoding operation to encode remaining visible patches of the ground truth DL precoder to a low dimensional latent vector; and identifies, based on the channel image encoding operation, the mask tokens corresponding to the remaining visible patches.

In one embodiment, the BS performs, based on a channel reconstruction decoder, the channel reconstruction decoding operation to reconstruct the ground truth DL precoder using the low dimensional latent vector and the mask tokens.

In one embodiment, the BS evaluates, based on an augmentation of NCG, a channel gain for calculating a loss during training the self-supervised learning model.

In one embodiment, the BS performs an up-sampling operation of a low resolution precoder using a zero padding.

In some embodiments, an RB masking operation uses a structured masking operation during interference time when an SB-level precoders is reconstructed to a down-sample precoder.

In some embodiments, the physics-based loss function uses, based on an IDFT and a weighting factor of a regularizer, an RB domain channel image in a frequency domain and a delay domain channel image in a time domain; and the physics-based loss function further uses ground truth RB-level CSI and reconstructed RB-level CSI to compute a loss for a backpropagation effect during training the self-supervised learning model.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the claims appended. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a processor configured to:
recover at least one resource block (RB)-level precoder based on at least one low-resolution RB-level precoder for obtaining a precoder gain,
configure, based on the at least one RB-level precoder, an up-sampling operation for channel state information (CSI) to train a self-supervised learning model without information including at least one of uplink (UL) CSI or a reference signal,
reconstruct, based on a physics-based loss function, the CSI using the self-supervised learning model for downlink (DL) CSI; and
a transceiver operably coupled to the processor, the transceiver configured to transmit, to a user equipment (UE), signals including information associated with the reconstructed CSI.

2. The BS of claim 1, wherein the at least one low-resolution RB-level precoder is identified, based on a channel image masking operation, with a uniform or non-uniform information loss for a down-sampling operation.

3. The BS of claim 1, wherein the processor is further configured to reconstruct the RB-level precoder using a random masking operation and a structured masking operation for reconstructing the CSI.

4. The BS of claim 3, wherein:
the structured masking operation is identified to directly imitate an RB-domain down-sampling to at least one subband (SB)-level precoder, antenna-dimensioned strips associated with patches for images being used for the structured masking operation to identify a relationship between the at least one RB-level precoder and the at least one SB-level precoder; and
the random masking operation is identified to assist a vision network for a distribution of a channel image.

5. The BS of claim 1, wherein:
the self-supervised learning model includes an RB masking operation, a channel image encoding operation, and a channel reconstruction decoding operation for obtaining an RB-level CSI prediction based on RB-level CSI; and
the processor is further configured to:
perform the RB masking operation using a ground truth DL precoder to perform, based on a random masking operation or a uniform masking operation, a positional embedding operation on each patch before transforming the patch, and
generate, based on the RB masking operation, mask tokens including positional information of the patch that is masked by the random masking operation or the uniform masking operation.

6. The BS of claim 5, wherein the processor is further configured to:
perform, based on a channel image encoder, the channel image encoding operation to encode remaining visible patches of the ground truth DL precoder to a low dimensional latent vector; and
identify, based on the channel image encoding operation, the mask tokens corresponding to the remaining visible patches.

7. The BS of claim 6, wherein the processor is further configured to perform, based on a channel reconstruction decoder, the channel reconstruction decoding operation to reconstruct the ground truth DL precoder using the low dimensional latent vector and the mask tokens.

8. The BS of claim 1, wherein the processor is further configured to evaluate, based on an augmentation of normalized channel gain (NCG), a channel gain for calculating a loss during training the self-supervised learning model.

9. The BS of claim 1, wherein:
the processor is further configured to perform an up-sampling operation of a low resolution precoder using a zero padding; and
an RB masking operation uses a structured masking operation during interference time when an SB-level precoders is reconstructed to a down-sample precoder.

10. The BS of claim 1, wherein:
the physics-based loss function uses, based on an inverse discrete Fourier transform (IDFT) and a weighting factor of a regularizer, an RB domain channel image in a frequency domain and a delay domain channel image in a time domain; and
the physics-based loss function further uses ground truth RB-level CSI and reconstructed RB-level CSI to compute a loss for a backpropagation effect during training the self-supervised learning model.

11. A method of a base station (BS) in a wireless communication system, the method comprising:
recovering at least one resource block (RB)-level precoder based on at least one low-resolution RB-level precoder for obtaining a precoder gain;
configuring, based on the at least one RB-level precoder, an up-sampling operation for channel state information (CSI) to train a self-supervised learning model without information including at least one of uplink (UL) CSI or a reference signal;
reconstructing, based on a physics-based loss function, the CSI using the self-supervised learning model for downlink (DL) CSI; and
transmitting, to a user equipment (UE), signals including information associated with the reconstructed CSI.

12. The method of claim 11, wherein the at least one low-resolution RB-level precoder is identified, based on a channel image masking operation, with a uniform or non-uniform information loss for a down-sampling operation.

13. The method of claim 11, further comprising reconstructing the RB-level precoder using a random masking operation and a structured masking operation for reconstructing the CSI.

14. The method of claim 13, wherein:
the structured masking operation is identified to directly imitate an RB-domain down-sampling to at least one subband (SB)-level precoder, antenna-dimensioned strips associated with patches for images being used for the structured masking operation to identify a relationship between the at least one RB-level precoder and the at least one SB-level precoder; and
the random masking operation is identified to assist a vision network for a distribution of a channel image.

15. The method of claim 11, further comprising:
performing an RB masking operation using a ground truth DL precoder to perform, based on a random masking operation or a uniform masking operation, a positional embedding operation on each patch before transforming the patch; and
generating, based on the RB masking operation, mask tokens including positional information of the patch that is masked by the random masking operation or the uniform masking operation,
wherein the self-supervised learning model includes the RB masking operation, a channel image encoding operation, and a channel reconstruction decoding operation for obtaining an RB-level CSI prediction based on RB-level CSI.

16. The method of claim 15, further comprising:
performing, based on a channel image encoder, the channel image encoding operation to encode remaining visible patches of the ground truth DL precoder to a low dimensional latent vector; and
identifying, based on the channel image encoding operation, the mask tokens corresponding to the remaining visible patches.

17. The method of claim 16, further comprising performing, based on a channel reconstruction decoder, the channel reconstruction decoding operation to reconstruct the ground truth DL precoder using the low dimensional latent vector and the mask tokens.

18. The method of claim 11, further comprising evaluating, based on an augmentation of normalized channel gain (NCG), a channel gain for calculating a loss during training the self-supervised learning model.

19. The method of claim 11, further comprising performing an up-sampling operation of a low resolution precoder using a zero padding,
wherein an RB masking operation uses a structured masking operation during interference time when an SB-level precoders is reconstructed to a down-sample precoder.

20. The method of claim 11, wherein:
the physics-based loss function uses, based on an inverse discrete Fourier transform (IDFT) and a weighting factor of a regularizer, an RB domain channel image in a frequency domain and a delay domain channel image in a time domain; and
the physics-based loss function further uses ground truth RB-level CSI and reconstructed RB-level CSI to compute a loss for a backpropagation effect during training the self-supervised learning model.
